(19) United States
(12) Patent Application Publication
(10) Pub. No.: US 2025/0053436 A1
(43) Pub. Date: Feb. 13, 2025

(54) SYSTEM, METHOD AND APPARATUS FOR SCALABLE CONNECTION MANAGEMENT OF INTERFACE

(71) Applicant: Intel Corporation, Santa Clara, CA (US)

(72) Inventors: Rajaram Regupathy, Bangalore (IN); Reuven Rozic, Binyamina (IL); Xiong Zhang, Beijing (CN); Gil Fine, Modiin (IL); Dmitriy Berchanskiy, Roseville, CA (US); Nirmala Bailur, Bangalore (IN); Paul Crutcher, Welches, OR (US)

(21) Appl. No.: 18/723,551

(22) PCT Filed: Feb. 22, 2022
(86) PCT No.: PCT/CN2022/077199

§ 371 Date: Jun. 24, 2024

(51) Int. Cl. G06F 9/455; G06F 13/42

(52) U.S. Cl. CPC G06F 9/45558; G06F 13/4221; G06F 2009/45579; G06F 2213/0026

(57) ABSTRACT

In one embodiment, a system comprises: a processor to execute a native operating system (OS); and an interface circuit coupled to the processor, the interface circuit configured to tunnel communications of a plurality of tunneled protocols, the interface circuit to couple to at least one device via a first tunneled protocol, where a connection manager for the interface circuit is to execute in a user space of the native OS. Other embodiments are described and claimed.

### BACKGROUND

Client ecosystems are evolving, with newer software frameworks including Containers or virtualization or hybrid client in which existing operating system (OS) frameworks are restructured as part of an extended cloud ecosystem. Many client devices connect with peripherals via a serial interconnect such as via a Universal Serial Bus (USB) connection, e.g., an interconnect in accordance with the USB4 Base Specification (Oct. 27, 2021).

With USB4, a connection-oriented, tunneling architecture is defined to combine multiple protocols onto a single physical interface so that the total speed and performance of the interconnect can be dynamically shared by USB devices, Peripheral Component Interconnect Express (PCIe) or Display Port (DP) endpoints with its expanded bandwidth. USB4 can optionally also support a Thunderbolt™ interface and enable daisy-chaining of devices. However, path activation and protocol tunneling priorities, among other interface control are managed at a higher layer referred as Connection Manager (CM), which is typically implemented as an operating system driver or system firmware integrated within the platform. This CM entity is responsible for managing various aspects of the tunneled protocol including establishing connection, path, bandwidth and power management. The CM functionality is an exposed as PCIe function as part of host interface of USB4 in most of the platforms. However this arrangement prevents flexibility in the CM and limits scalability.

### BRIEF DESCRIPTION OF THE DRAWINGS

FIG. 1 is a block diagram of a network environment in accordance with an embodiment.

FIG. 2A is a block diagram of a client device in accordance with an embodiment.

FIG. 2B is a block diagram of a client device in accordance with another embodiment.

FIG. 3 is a block diagram of a client device in accordance with yet another embodiment.

FIG. 4 is flow diagram of a method in accordance with an embodiment.

FIG. 5 is an embodiment of a fabric composed of point-to-point links that interconnect a set of components.

FIG. 6 is an embodiment of a system-on-chip design in accordance with an embodiment.

FIG. 7 is a block diagram of a system in accordance with an embodiment of the present invention

### DETAILED DESCRIPTION

In various embodiments, a client device is implemented with a configuration in which a control plane or connection manager for an input/output (I/O) interface, e.g., a serial I/O interface, may be decoupled from the platform to provide a scalable and securely manageable framework. To this end, embodiments may map the control plane to a user space of a native OS, such that the CM is implemented as user land. In one implementation, user land frameworks may implement application programming interfaces (APIs) to allow cloud frameworks to effectively manage the interface. In different implementations, various services may integrate a management interface that allows the cloud infrastructure to scale and securely manage interface functionalities.

In an alternate embodiment, the CM may be virtualized via a virtual CM implemented in one or more Guest OSes. In this arrangement, a native OS may trap CM command operations using a CM Aggregator, which can be implemented as part of a CM Daemon in the native OS, thus effectively managing the interface.

Embodiments may thus decouple a control plane of a USB4 or other interface from the OS/platform. In this way, enhanced scalability and security of the CM may be realized for hybrid client systems implementing containers and/or virtualization. Stated another way, tunneled protocols of a usb4 interface may be effectively managed in a cloud client or virtualized environment by defining a cross-virtual OS or microservice CM that communicates a state and needs of the tunneled protocol virtualized on the particular guest OS.

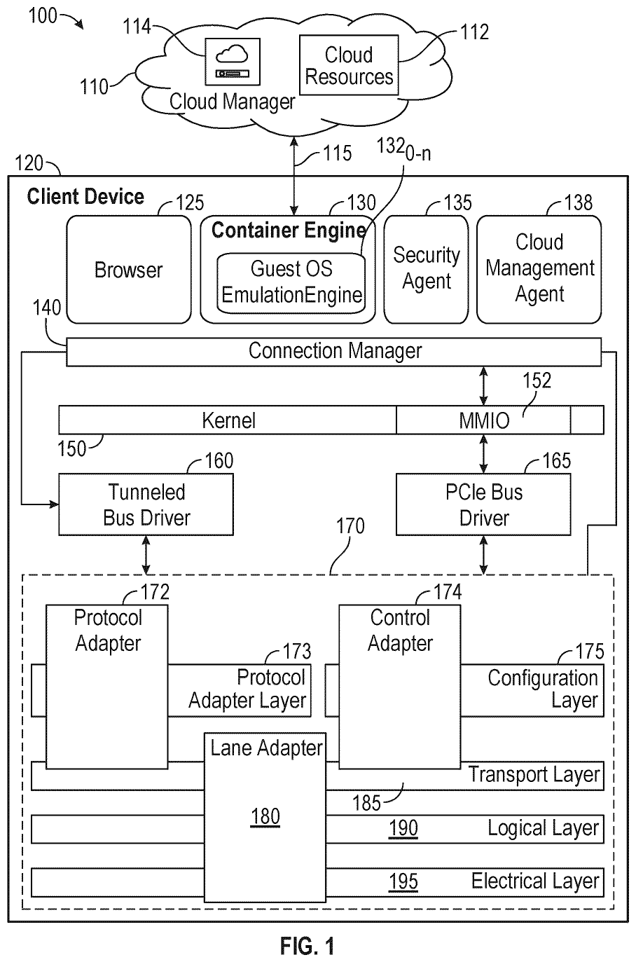

Referring now to FIG. 1, shown is a block diagram of a network environment in accordance with an embodiment. As shown in FIG. 1, network 100 may be a cloud-based network having a cloud architecture 110 such as present in one or more data centers. Cloud architecture 110 couples via a network 115, e.g., the Internet, to a client device 120. In embodiments herein, client device 120 may be any type of client computing device, ranging from a desktop computer such as a traditional client desktop to a thin client, laptop computer, tablet or so forth. In embodiments herein, cloud and user interaction with other devices such as peripherals (not shown for ease of illustration in FIG. 1) coupled to client device 120 may be via a serial protocol such as a Universal Serial Bus (USB) 4 protocol (USB4), e.g., in accordance with the USB4 Base Specification (Oct. 27, 2021). Such communications may include tunneled communications of other protocols including Peripheral Component Interconnect Express (PCIe), e.g., in accordance with the PCIe 5.0 Specification (May 29, 2021), other USB protocols such as earlier or future versions of the protocol, or Thunderbolt™ protocols.

Although embodiments are not limited in this regard, client device 120 may be implemented in a cloud ecosystem having a cloud first client or hybrid client framework in which existing OS frameworks are restructured. Without an embodiment, the CM would be tightly coupled with a native OS, which limits the microservices or virtual solutions. Such conventional CM implementation would prevent flexibility in the control plane (CM) with hybrid OSes, where resources are to be shared for efficient management, which could lead to inefficient usage platform resource and bad user experience. This conventional CM implementation may limit an ability to scale and provide secure userland service or virtual solutions for efficient management of a hybrid client or cloud first client. This is so, since a conventional CM lacks an ability to communicate between multiple virtual OSes or microservices since it is confined within a kernel or platform, and thus cannot manage protocols tunneled to other virtual OSes or micro services

In an embodiment, client device 120 may be implemented as a hybrid client (or cloud client device) that has an intelligent unified management solution to manage its resources from cloud architecture 110. In this way, automated processes and intelligent insights may be provided with dynamic device-grouping and rules-based automation, as examples.

Still with reference to FIG. 1, cloud architecture 110 may include various cloud resources 112 such as processing, memory, storage, networking among other hardware-based resources that may be virtualized and accessed by various client devices. Such operations may occur under control of a cloud manager 114. With embodiments herein, in some use cases cloud manager 114 manages interface circuitry within client device 120 via a virtualization model.

To this end, client device 120 may implement a connection manager 140 for an interface circuit 170 (which in the embodiment shown is a USB4 interface circuit) in a user space, effectively decoupling the control plane for this interface from the platform. That is, in contrast to conventional implementations in which a connection manager is implemented in and tightly coupled to a native operating system (OS) and/or platform firmware, embodiments provide a connection manager within a user space. In one or more embodiments, connection manager 140 may be implemented within one or more hardware circuits. For example, one embodiment connection manager 140 may be implemented within peripheral hub circuitry, which may be part of a multicore processor or other system on chip (SoC).

Before describing various software that executes within hardware of client device 120, a client mode architecture of client device 120 is outlined. As seen, a kernel 150 is present which may be implemented as part of a host or native OS. As illustrated, kernel 150 includes a memory mapped I/O (MMIO) component 152 that may be used to map connection manager 140 to the user space. As shown, MMIO component 152 may communicate with a PCIe bus driver 165 that interacts with interface circuit 170. As also shown, connection manager 140 may communicate directly with a tunneled bus driver 160 that also interacts with interface circuit 170.

Still with reference to FIG. 1, a protocol adapter 172 that communicates with tunneled bus driver 160 may be part of a protocol adapter layer 173 and further interfaces with a transport layer 185. In turn, a control adapter 174 that communicates with PCIe bus driver 165 may be part of a configuration layer 175 and further interfaces with transport layer 185. Interface circuit 170 also includes one or more lane adapters 180 that may be implemented throughout a layered protocol, including transport layer 185, a logical layer 190, and an electrical layer 195, which may provide for USB4 and/or tunneled communications of other protocols with one or more peripheral devices to which client device 120 couples.

Still with reference to FIG. 1, via this client mode connection manager within the virtualization model shown in FIG. 1, various software resources may manage a topology of different protocols via interface circuit 170. As shown, these software resources may include one or more browsers 125, a container engine 130 via which one or more guest OS emulation engines 132_{0-N} may be present, a security agent 135, and a cloud management agent 138. Note that while in FIG. 1, client device 120 is shown with a software-based representation, such software, and/or firmware, may execute on underlying hardware resources of the platform in addition to interface circuit 170, including one or more processors that interact with memory, storage, acceleration resources, and so forth present within client device 120. Also while shown with this particular implementation in FIG. 1, understand that variations and alternatives are possible.

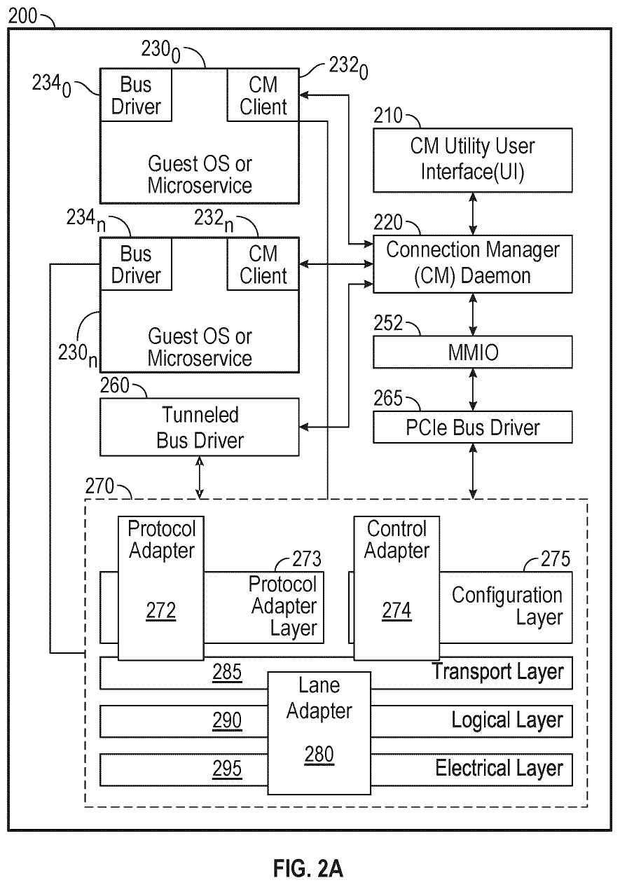

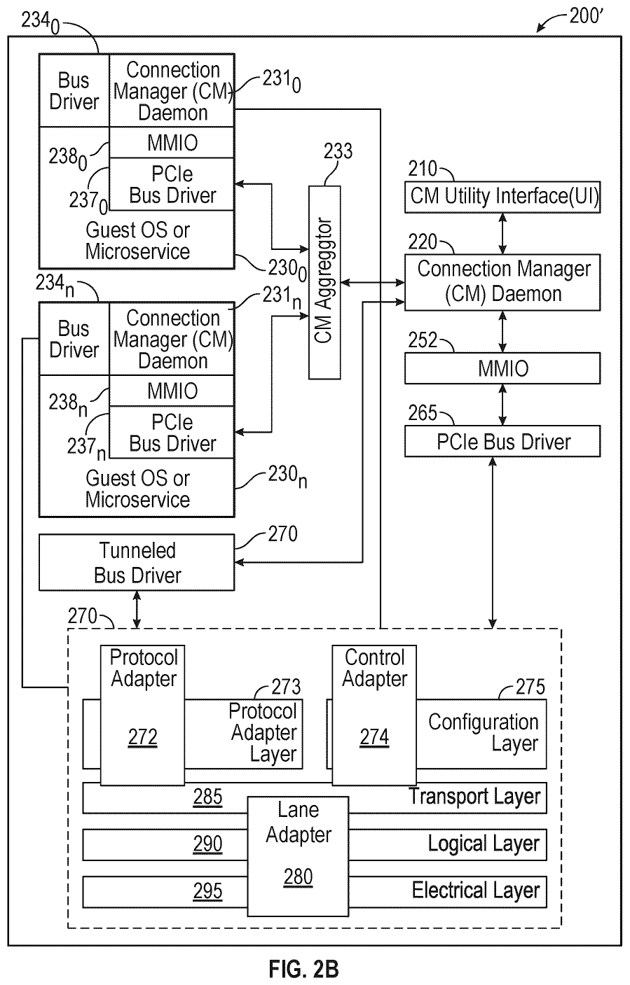

Referring now to FIG. 2A, shown is a block diagram of a client device having a common control plane daemon implementation in accordance with an embodiment. As shown in FIG. 2A, client device 200 may be implemented similarly to client device 120 of FIG. 1. Common components are thus not described again, and bear the same series of numbering as in FIG. 1 (albeit of the “200” series). As shown, a host OS may have a connection manager utility user interface (UI) 210 that is mapped to the user space. With embodiments, a connection manager's memory space may be mapped via a kernel framework that maps PCIe memory space to user space. As shown, user interface 210 communicates with a connection manager daemon 220, which may traverse a router path to build a topology and listen to ports.

As shown in FIG. 2A, connection manager daemon 220 may communicate via sessions with corresponding connection manager (CM) clients 2320-232N, which may be part of corresponding guest OSs or microservices 230₀-230_{N}. In this way, connection manager daemon 220 may set up sessions with CM clients 232 to communicate the status of a tunneled protocol to the native OS connection manager daemon. The communication framework between CM clients 232 and connection manager daemon 220 may be memory-based or via a packet-based broadcast mechanism. As further shown, these guests OS 230 also may include corresponding bus drivers 234₀-234_{N}.

As further illustrated in FIG. 2A, client device 200 may implement an interface circuit 270 that is the same as described above with regard to interface circuit 170 of FIG. 1 (and thus is not further described here). As shown, interaction with interface circuit 270 may be via a tunneled bus driver 260 and a PCIe bus driver 265.

Other embodiments are possible. For example, a host interface connection manager may be mapped to user space, and guest OSs and/or microservices may be mapped with a virtual connection manager. In such implementations, communications from a guest OS virtual connection manager may be memory trapped and monitored to be aggregated to a native OS connection manager that in turn may manage an interface circuit, e.g., a USB4 interface.

As now shown in FIG. 2B, a client device 200′ may be implemented with a CM aggregation technique in accordance with another embodiment. In general, client device 200′ may be implemented similarly to client device 200 of FIG. 2A. However in this arrangement, each guest OS or microservice 230 may include a guest OS virtual connection manager 231 that sends communications that may be memory trapped and monitored to be aggregated to the native OS connection manager. TO this end, a connection manager aggregator 233 aggregates these communications (e.g., interface management requests) and in turn communicates them to connection manager daemon 220. As further shown, each guest OS/microservice 230 also include as a PCIe bus driver 237 and a MMIO component 238. In other aspects, client device 200′ may be implemented the same as discussed above with regard to client device 200 of FIG. 2A.

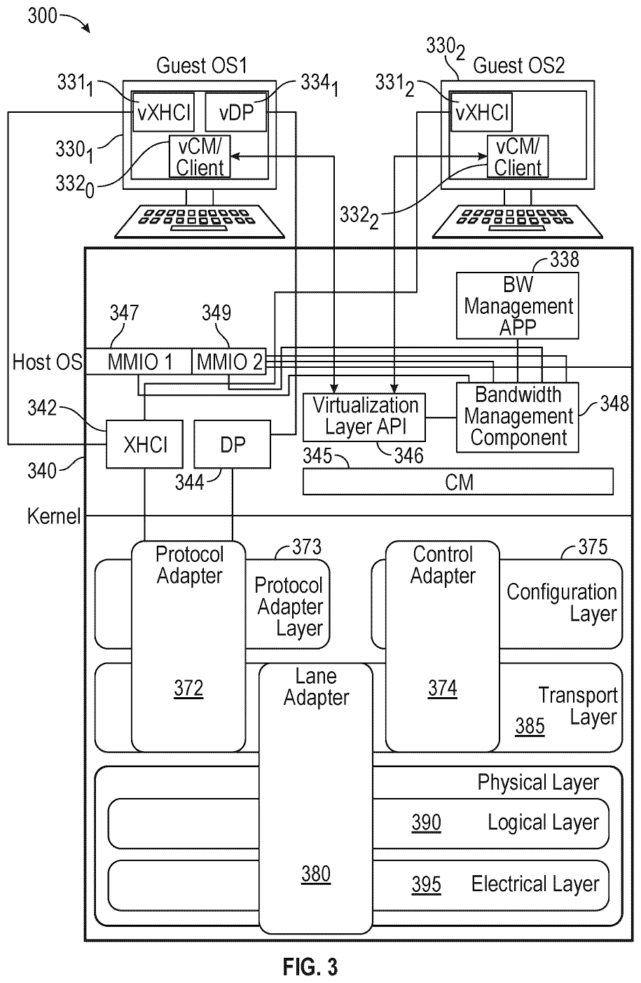

In yet other embodiments, a virtualization layer, which may be implemented as an application programming interface (API), may act as an interface between virtual connection managers of various guest OSs and an underlying connection manager of a kernel. Referring now to FIG. 3, shown is a block diagram of a client device in accordance with yet another embodiment. As shown in FIG. 3, multiple guest OSs 330₁₋₂ are present, each including a virtual extended host controller interface (vXHCI) 331_{1,2}, a virtual connection manager 332_{1,2}, and a virtual display port 334₁ (in guest OS 330₁ (optionally)) that communicates via different MMIO regions 347, 349 of a host OS 340 to enable interaction with a corresponding XHCI 342, a display port component 344, and a connection manager 345. To this end, to interact with connection manager 345, a virtualization layer 346 (which may be implemented as an API) communicates with corresponding virtual CMs 332 of the different guest OSs 330. As further shown, a bandwidth management component 348 may communicate with a bandwidth management application 338.

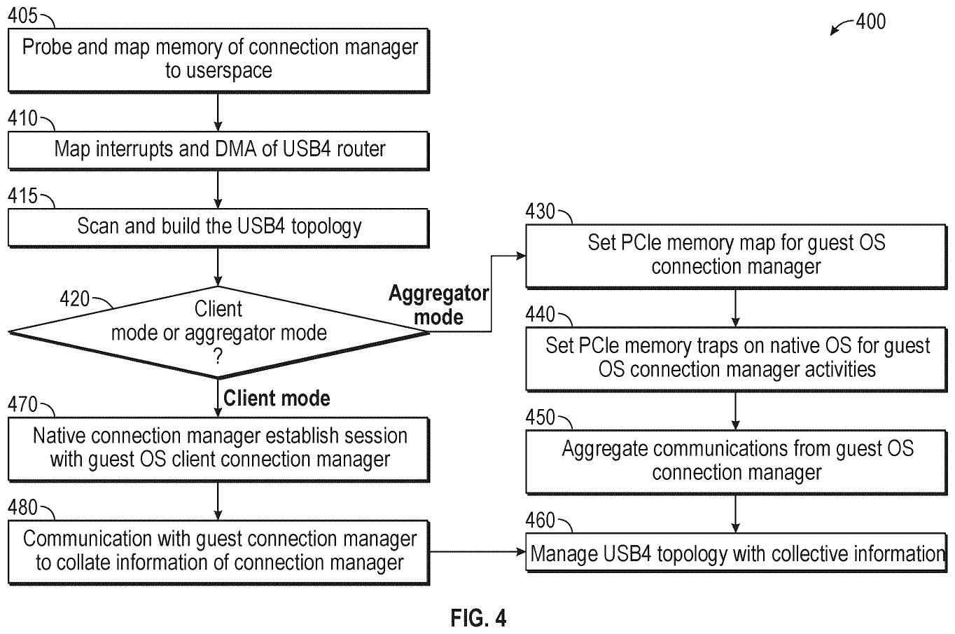

Referring now to FIG. 4, shown is a flow diagram of a method for managing a control plane architecture for a client system in accordance with an embodiment. As illustrated in FIG. 4, method 400 may be performed by various hardware of a client system that interfaces with OS and/or kernel components, along with user space components. As such, method 400 may be performed by various hardware circuitry present within a client device.

Method 400 begins by probing and mapping a memory of a connection manager to user space (block 405). In an embodiment, this memory mapping may be effected by mapping a PCIe memory mapped region to the user space. Next at block 410, interrupts and direct memory accesses (DMAs) may be mapped for a USB4 router. Then at block 415, based at least in part on the mappings described above, a USB port topology may be scanned and built. Next it may be determined whether operations are to be in a client mode or an aggregator mode (as determined at diamond 420).

If operation is to be in an aggregator mode (such as in the embodiment of FIG. 2B), control passes to block 430 where a PCIe memory mapping may be set for a guest OS connection manager. Then at block 440 the PCIe memory traps may be set on the native OS for guest OS connection manager activities. As such, during normal operations, communications from the guest connection manager may be aggregated (block 450). From this aggregated information, the USB topology may be managed (block 460).

Still with reference to FIG. 4, instead if it is determined that a client mode is to be active, control passes from diamond 420 to block 470 where a native connection manager may establish a session with a guest OS client connection manager. Then at block 480, the native connection manager may communicate with the guest connection manager to collate information. Control may then pass again to block 460, where the USB4 topology may be managed based on this information. Understand while shown at this high level in the embodiment of FIG. 4, many variations and alternatives are possible.

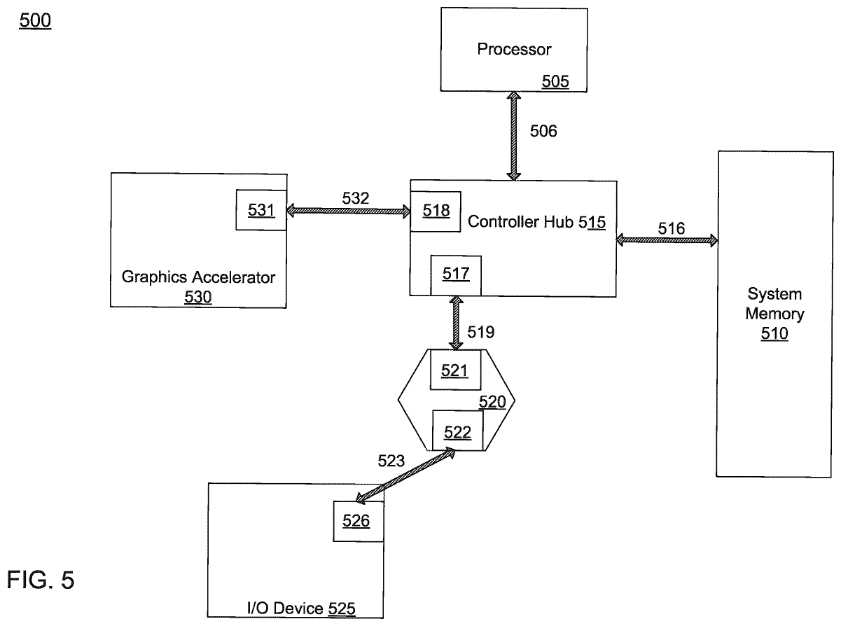

Embodiments may be implemented in a wide variety of systems. Referring to FIG. 5, an embodiment of a fabric composed of point-to-point links that interconnect a set of components is illustrated. System 500 includes processor 505 and system memory 510 coupled to controller hub 515. Processor 505 includes any processing element, such as a microprocessor, a host processor, an embedded processor, a co-processor, or other processor. Processor 505 is coupled to controller hub 515 through a link 506, such as an Intel® UPI serial point-to-point interconnect.

System memory 510 includes any memory device, such as random access memory (RAM), non-volatile (NV) memory, or other memory accessible by devices in system 500. System memory 510 is coupled to controller hub 515 through memory interface 516. Examples of a memory interface include a double-data rate (DDR) memory interface, a dual-channel DDR memory interface, and a dynamic RAM (DRAM) memory interface.

In one embodiment, controller hub 515 is a root hub, root complex, or root controller in a PCIe interconnection hierarchy. Examples of controller hub 515 include a chipset, a memory controller hub (MCH), a northbridge, an interconnect controller hub (ICH), a southbridge, and a root controller/hub. Often the term chipset refers to two physically separate controller hubs, i.e. a memory controller hub (MCH) coupled to an interconnect controller hub (ICH). Note that current systems often include the MCH integrated with processor 505, while controller 515 is to communicate with I/O devices, in a similar manner as described below. In some embodiments, peer-to-peer routing is optionally supported through root complex 515.

Here, controller hub 515 is coupled to switch/bridge 520 through serial link 519. Input/output modules 517 and 521, which may also be referred to as interfaces/ports 517 and 521, include/implement a layered protocol stack to provide communication between controller hub 515 and switch 520. In one embodiment, multiple devices are capable of being coupled to switch 520. Switch/bridge 520 couples to a device 525 through an interconnect 523 (e.g., a USB4 link) via corresponding interfaces/ports 522 and 526.

Switch/bridge 520 routes packets/messages from device 525 upstream, i.e., up a hierarchy towards a root complex, to controller hub 515 and downstream, i.e., down a hierarchy away from a root controller, from processor 505 or system memory 510 to device 525. Device 525 may be any peripheral including any internal or external device or component to be coupled to an electronic system e.g., via a USB4 or other serial interface that provides for communication of one or more tunneled protocols in accordance with an embodiment. Device 525 may be an I/O device, a NIC, an add-in card, an audio processor, a network processor, a memory expander, a hard-drive, a storage device such as a solid state drive, a CD/DVD ROM, a monitor, a printer, a mouse, a keyboard, a router, a portable storage device, a Firewire device, a USB device, a scanner, and other input/output devices.

Graphics accelerator 530 is also coupled to controller hub 515 through serial link 532. In one embodiment, graphics accelerator 530 is coupled to an MCH, which is coupled to an ICH. Switch 520, and accordingly I/O device 525, is then coupled to the ICH. I/O modules 531 and 518 are also to implement a layered protocol stack to communicate between graphics accelerator 530 and controller hub 515. A graphics controller or the graphics accelerator 530 itself may be integrated in processor 505.

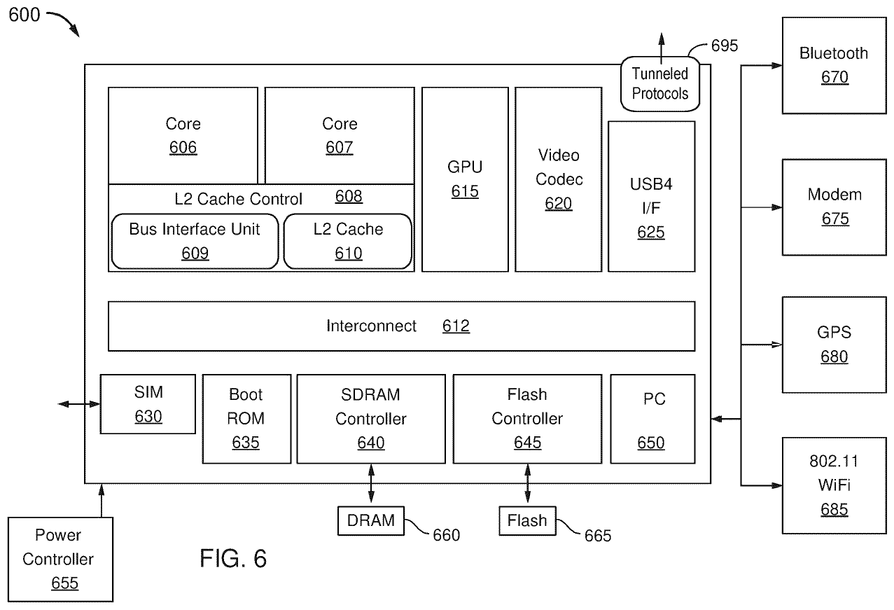

Turning next to FIG. 6, an embodiment of a SoC design in accordance with an embodiment is depicted. As a specific illustrative example, SoC 600 may be configured for insertion in any type of computing device, ranging from portable device to server system. Here, SoC 600 includes 2 cores 606 and 607. Cores 606 and 607 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 606 and 607 are coupled to cache controller 608 that is associated with bus interface unit 609 and L2 cache 610 to communicate with other parts of system 600 via an interconnect 612.

Interconnect 612 provides communication channels to the other components, such as a Subscriber Identity Module (SIM) 630 to interface with a SIM card, a boot ROM 635 to hold boot code for execution by cores 606 and 607 to initialize and boot SoC 600, a SDRAM controller 640 to interface with external memory (e.g., DRAM 660), a flash controller 645 to interface with non-volatile memory (e.g., flash 665), a peripheral controller 650 to interface with peripherals, video codec 620 and GPU 615 to perform graphics related computations, etc. In addition, the system illustrates peripherals for communication, such as a Bluetooth module 670, 3G modem 675, GPS 680, and WiFi 685.

Also included in the system is a power controller 655. Further illustrated in FIG. 6, system 600 may additionally include interfaces including a USB4 interface 625 that may be virtualized as described herein, and may couple to one or more peripheral devices via one or more tunneled protocols 695.

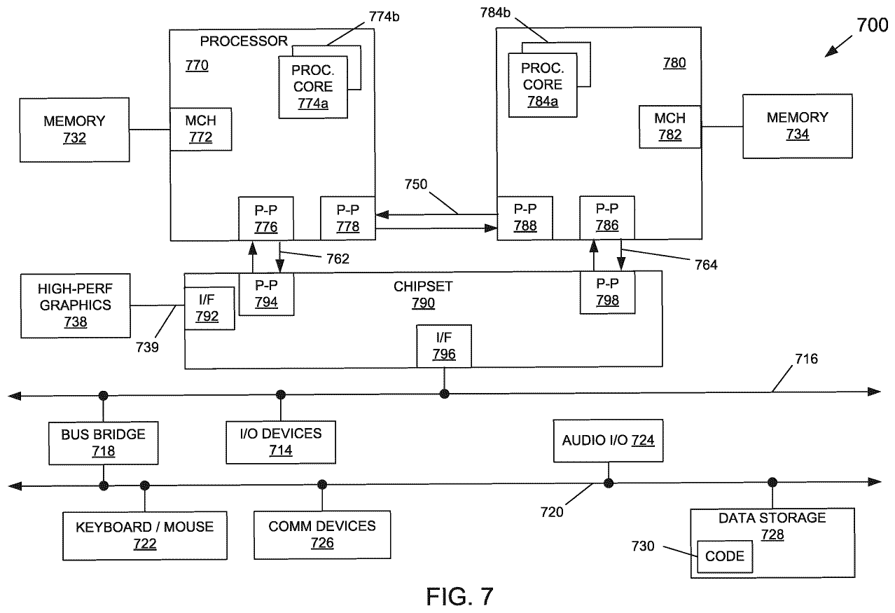

Referring now to FIG. 7, shown is a block diagram of a system in accordance with an embodiment. As shown in FIG. 7, multiprocessor system 700 may be a cloud client or other hybrid client device to interface with a cloud infrastructure as described herein. As shown system 700 includes a first processor 770 and a second processor 780 coupled via a point-to-point interconnect 750. As shown in FIG. 7, each of processors 770 and 780 may be many core processors including representative first and second processor cores (i.e., processor cores 774a and 774b and processor cores 784a and 784b).

Still referring to FIG. 7, first processor 770 further includes a memory controller hub (MCH) 772 and point-to-point (P-P) interfaces 776 and 778. Similarly, second processor 780 includes a MCH 782 and P-P interfaces 786 and 788. As shown in FIG. 7, MCH's 772 and 782 couple the processors to respective memories, namely a memory 732 and a memory 734, which may be portions of system memory (e.g., DRAM) locally attached to the respective processors. First processor 770 and second processor 780 may be coupled to a chipset 790 via P-P interconnects 762 and 764, respectively. As shown in FIG. 7, chipset 790 includes P-P interfaces 794 and 798.

Furthermore, chipset 790 includes an interface 792 to couple chipset 790 with a high performance graphics engine 738, by a P-P interconnect 739. As shown in FIG. 7, various input/output (I/O) devices 714 may be coupled to a first bus 716, along with a bus bridge 718 which couples first bus 716 to a second bus 720. One or more of I/O devices 714 may couple to system 700 via a USB4 interface that can be virtualized as described herein.

Various devices may be coupled to second bus 720 including, for example, a keyboard/mouse 722, communication devices 726 and a data storage unit 728 such as a disk drive or other mass storage device which may include code 730, in one embodiment. Further, an audio I/O 724 may be coupled to second bus 720.

The following examples pertain to further embodiments.

In one example, a system comprises: a processor to execute a native OS; and an interface circuit coupled to the processor, the interface circuit configured to tunnel communications of a plurality of tunneled protocols, the interface circuit to couple to at least one device via a first tunneled protocol; wherein a connection manager for the interface circuit is to execute in a user space of the native OS.

In an example, the system further comprises a PCIe memory space, wherein at least a portion of the PCIe memory space comprises the connection manager, wherein the connection manager is mapped to the user space.

In an example, the connection manager is decoupled from the system, the connection manager comprising a connection manager daemon.

In an example, the connection manager comprises a control plane for the interface circuit.

In an example, the connection manager comprises a virtualized connection manager to handle interface requests from a plurality of guest OSs, the native OS comprising a host OS.

In an example, the native OS comprises a connection manager daemon to receive a first command operation to cause the interface circuit to be virtualized for communication via the first tunneled protocol, the first command operation from a first guest OS of the plurality of guest OSs.

In an example, the connection manager daemon is to receive a second command operation to cause the interface circuit to be virtualized for communication via a second tunneled protocol, the second command operation from a second guest OS of the plurality of guest OSs.

In an example, the system further comprises a connection manager aggregator to trap the first command operation and direct the first command operation to a tunneled bus driver via the connection manager daemon.

In an example, the system further comprises at least one application programming interface to enable a cloud entity to manage the interface circuit, wherein the system comprises a client device.

In an example, the interface circuit comprises a USB interface circuit and the first tunneled protocol comprises a Thunderbolt protocol.

In an example, the processor comprises a peripheral hub circuit to execute the connection manager.

In another example, a method comprises: mapping a memory space of a connection manager for a USB interface circuit to a user space of a native OS of a cloud client device; receiving a first management request from a first guest OS, the first management request for the USB interface circuit; and managing a topology of the USB interface circuit, via the connection manager mapped to the user space, based at least in part on the first management request.

In an example, the method further comprises, in an aggregator mode, trapping the first management request from a virtual connection manager of the first guest OS, in a connection manager aggregator, and providing the first management request to a connection manager daemon of the native OS.

In an example, the method further comprises communicating directly between the connection manager daemon and a tunneled bus driver of the native OS, the tunneled bus driver to interface with a protocol adapter of the USB interface circuit.

In an example, the method further comprises, in a client mode, establishing a session between the connection manager and a first guest connection manager of the first guest OS.

In an example, the method further comprises communicating with the first guest connection manager to collate information comprising the first management request and managing the topology of the USB interface circuit using the collated information.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises a client device and a peripheral device coupled to the client device via a USB link. The client device comprises: a processor to execute a native OS; and a USB interface circuit coupled to the processor, the USB interface circuit configured to tunnel communications of a plurality of tunneled protocols, the USB interface circuit to couple to a peripheral device via a first tunneled protocol, wherein a connection manager for the USB interface circuit is to execute in a user space of the native OS.

In an example, the client device comprises a hybrid client device to be managed by a cloud entity, wherein the cloud entity is to further manage the USB link via the connection manager.

In an example, the system further comprises at least one application programming interface to enable the cloud entity to manage the USB interface circuit.

In an example, the connection manager comprises a virtualized connection manager to handle interface requests from a plurality of guest OSs, the native OS comprising a connection manager daemon to receive a first command operation to cause the USB interface circuit to be virtualized for communication via the first tunneled protocol, the first command operation from a first guest OS of the plurality of guest OSs.

In another example, a system comprises: processor means for executing a native OS; and interface means coupled to the processor means, the interface means for tunneling communications of a plurality of tunneled protocols, the interface means to couple to at least one device via a first tunneled protocol; wherein a connection manager means for the interface means is to execute in a user space of the native OS.

In another example, an apparatus comprises: means for mapping a memory space of a connection manager for a USB interface means to a user space of a native OS of a cloud client device; means for receiving a first management request from a first guest OS, the first management request for the USB interface means; and means for managing a topology of the USB interface means, via the connection manager mapped to the user space, based at least in part on the first management request.

In an example, the apparatus further comprises: means for trapping the first management request from a virtual connection manager of the first guest OS; and means for providing the first management request to a connection manager daemon of the native OS.

In an example, the apparatus further comprises means for communicating directly between the connection manager daemon and a tunneled bus driver of the native OS, the tunneled bus driver to interface with a protocol adapter of the USB interface means.

In an example, the apparatus further comprises means for establishing a session between the connection manager and a first guest connection manager of the first guest OS.

In an example, the apparatus further comprises means for communicating with the first guest connection manager to collate information comprising the first management request.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

1. A system comprising:
a processor to execute a native operating system (OS); and
an interface circuit coupled to the processor, the interface circuit configured to tunnel communications of a plurality of tunneled protocols, the interface circuit to couple to at least one device via a first tunneled protocol;
wherein a connection manager for the interface circuit is to execute in a user space of the native OS.

2. The system of claim 1, further comprising a Peripheral Component Interconnect Express (PCIe) memory space, wherein at least a portion of the PCIe memory space comprises the connection manager, wherein the connection manager is mapped to the user space.

3. The system of claim 1, wherein the connection manager is decoupled from the system, the connection manager comprising a connection manager daemon.

4. The system of claim 1, wherein the connection manager comprises a control plane for the interface circuit.

5. The system of claim 1, wherein the connection manager comprises a virtualized connection manager to handle interface requests from a plurality of guest OSs, the native OS comprising a host OS.

6. The system of claim 5, wherein the native OS comprises a connection manager daemon to receive a first command operation to cause the interface circuit to be virtualized for communication via the first tunneled protocol, the first command operation from a first guest OS of the plurality of guest OSs.

7. The system of claim 6, wherein the connection manager daemon is to receive a second command operation to cause the interface circuit to be virtualized for communication via a second tunneled protocol, the second command operation from a second guest OS of the plurality of guest OSs.

8. The system of claim 6, further comprising a connection manager aggregator to trap the first command operation and direct the first command operation to a tunneled bus driver via the connection manager daemon.

9. The system of claim 1, further comprising at least one application programming interface to enable a cloud entity to manage the interface circuit, wherein the system comprises a client device.

10. The system of claim 1, wherein the interface circuit comprises a Universal Serial Bus (USB) interface circuit and the first tunneled protocol comprises a Thunderbolt protocol.

11. The system of claim 1, wherein the processor comprises a peripheral hub circuit to execute the connection manager.

12. A method comprising:
mapping a memory space of a connection manager for a universal serial bus (USB) interface circuit to a user space of a native operating system (OS) of a cloud client device;
receiving a first management request from a first guest OS, the first management request for the USB interface circuit; and
managing a topology of the USB interface circuit, via the connection manager mapped to the user space, based at least in part on the first management request.

13. The method of claim 12, further comprising, in an aggregator mode, trapping the first management request from a virtual connection manager of the first guest OS, in a connection manager aggregator, and providing the first management request to a connection manager daemon of the native OS.

14. The method of claim 13, further comprising communicating directly between the connection manager daemon and a tunneled bus driver of the native OS, the tunneled bus driver to interface with a protocol adapter of the USB interface circuit.

15. The method of claim 12, further comprising, in a client mode, establishing a session between the connection manager and a first guest connection manager of the first guest OS.

16. The method of claim 15, further comprising communicating with the first guest connection manager to collate information comprising the first management request and managing the topology of the USB interface circuit using the collated information.

17. A system comprising:
a client device comprising:
a processor to execute a native operating system (OS); and
a Universal Serial Bus (USB) interface circuit coupled to the processor, the USB interface circuit configured to tunnel communications of a plurality of tunneled protocols, the USB interface circuit to couple to a peripheral device via a first tunneled protocol, wherein a connection manager for the USB interface circuit is to execute in a user space of the native OS; and
the peripheral device coupled to the client device via a USB link.

18. The system of claim 17, wherein the client device comprises a hybrid client device to be managed by a cloud entity, wherein the cloud entity is to further manage the USB link via the connection manager.

19. The system of claim 18, further comprising at least one application programming interface to enable the cloud entity to manage the USB interface circuit.

20. The system of claim 17, wherein the connection manager comprises a virtualized connection manager to handle interface requests from a plurality of guest OSs, the native OS comprising a connection manager daemon to receive a first command operation to cause the USB interface circuit to be virtualized for communication via the first tunneled protocol, the first command operation from a first guest OS of the plurality of guest OSs.

21-25. (canceled)
